(19) United States
(12) Patent Application Publication
(10) Pub. No.: US 2026/0086580 A1
(43) Pub. Date: Mar. 26, 2026

(54) MASS FLOW CONTROLLER

(71) Applicant: Kuwana Metals, Ltd., Kuwana-shi (JP)

(72) Inventor: Takao Goto, Tokyo (JP)

(73) Assignee: Kuwana Metals, Ltd., Kuwana-shi (JP)

(21) Appl. No.: 19/110,858

(22) PCT Filed: Jul. 25, 2023
(86) PCT No.: PCT/JP2023/027179

§ 371 Date: Mar. 12, 2025

(30) Foreign Application Priority Data
Sep. 16, 2022 (JP) 2022-147684

(51) Int. Cl. G05D 7/06

(52) U.S. Cl. CPC G05D 7/0635

(57) ABSTRACT

A mass flow controller performs flow rate control depending on supply periods. In a period from a first time point to a second time point t, a valve opening degree signal is output to a flow rate control valve such that a flow rate measured value determined based on a flow rate signal is larger than the first setting value. In a period from the second time point to a third time point, the valve opening degree signal is output to the flow rate control valve such that the flow rate measured value coincides with the first setting value, and in a period from the third time point to a time point when the first setting value is next input, the valve opening degree signal is output to the flow control valve such that the flow rate measured value coincides with the second setting value.

### FIELD

The present invention relates to a mass flow controller which supplies a fluid intermittently. Although not particularly limited, the present invention relates to a mass flow controller suitable for manufacturing semiconductors by atomic layer deposition.

### BACKGROUND

A mass flow controller is a precision instrument mainly used for manufacturing semiconductors. A mass flow controller comprises a flow sensor which outputs a flow rate signal corresponding to a flow rate of a fluid, a flow control valve which controls the flow rate of the fluid by adjusting an opening degree of a valve, a flow rate setting means for inputting the a flow rate setting value, and a control which outputs a valve opening degree signal to the flow rate control valve. As typical applications of mass flow controllers in manufacturing of semiconductors, for example, an application in which a material gas is supplied to a substrate placed inside a reaction chamber of semiconductor manufacturing apparatus via piping connected downstream of the mass flow controller to perform film formation (deposition), etc. can be exemplified.

In association with technological innovations in manufacturing methods of semiconductors, new specifications are required for mass flow controllers. For example, in a technology called Atomic Layer Deposition (which will be referred to as “ALD” hereafter), highly precise and homogeneous thin film with controlled film thickness and composition at an atomic layer level is formed by alternately supplying multiple types of material gases in small amounts to a surface of a substrate. In mass flow controllers used in ALD, it is required to repeat in a constant period a cycle in which a material gas with a controlled flow rate is supplied for a short period of about 2 to 3 seconds and thereafter the supply of the material gas is cut off.

In the art, mass flow controllers suitable for alternately repeating on and off of gas supply in short cycles as mentioned above have been proposed. For example, in Japanese Patent Application Laid-Open (kokai) No. 2022-83102 (“PTL1”), an invention of a mass flow controller which can maintain responsiveness in flow rate control in a state at the time of factory shipment even when the flow rate control valve becomes fatigued due to repeated opening and closing is described. Moreover, for example, in Japanese Patent Application Laid-Open (kokai) No. 2021-157728 (“PTL2”), an invention of a mass flow controller which can solve response delays and deviations in the timing of supplying a material gas by arranging a plurality of devices radially in the vicinity of a reaction chamber is described.

### SUMMARY

An aspect may be characterized as a mass flow controller comprising a flow sensor which outputs a flow rate signal corresponding to a flow rate of a fluid, a flow control valve which controls the flow rate of said fluid by adjusting an opening degree of the valve, a flow rate setting means to which a flow rate setting value of said fluid is input, and a control means which outputs a valve opening degree signal to said flow control valve. Said mass flow controller performs flow rate control at an action position where said fluid acts at different flow rates depending on supply periods. Said control means is configured to, in a first period from a first time point that is a time point when a first setting value that is a flow rate setting value other than zero is input to said flow rate setting means to a second time point that is a time point when it is judged that said fluid has reached said action position, output said valve opening degree signal to said flow rate control valve such that a flow rate measured value determined based on said flow rate signal is larger than said first setting value. In addition, said control means is configured to, in a second period from said second time point to a third time point that is a time point when a second setting value that is a flow rate setting value smaller than said the first setting value is input to said flow rate setting means, output said valve opening degree signal to said flow rate control valve such that said flow rate measured value coincides with said first setting value. Said control means is also configured to, in a third period from said third time point to a time point when said first setting value is next input, output said valve opening degree signal to said flow control valve such that said flow rate measured value coincides with said second setting value, and said control means is configured to repeatedly execute a control cycle comprising said first period, said second period and said third period one or more times.

### BRIEF DESCRIPTION OF THE DRAWINGS

FIG. 1 is a schematic diagram for exemplifying a mode of use of the mass flow controller according to the present invention.

FIG. 2 is a schematic block diagram for showing an example of a configuration of the mass flow controller according to the present invention.

FIG. 3 is a graph for exemplifying a change with respect to time (t) of the intensity (a) of the valve opening degree signal in the mass flow controller according to the present invention.

FIG. 4 is a graph for exemplifying changes with respect to time (t) of the intensity (a) of the valve opening degree signal, the flow rate measured value (b) and the flow rate (c) of the material gas at the action position in the mass flow controller according to the present invention.

FIG. 5 is a graph for exemplifying a change with respect to time (t) of the flow rate indicated value (d) in the mass flow controller according to a preferred embodiment of the present invention.

FIG. 6 is a graph for exemplifying changes with respect to time (t) of the intensity (a′) of the valve opening degree signal, the measured flow rate (b′) and the flow rate (c′) of the material gas at the action position in a mass flow controller according to the prior art.

### DETAILED DESCRIPTION

### Technical Problem

A supply unit of a material gas including a mass flow controller is often provided outside a main body of semiconductor manufacturing apparatus, the mass flow controller and reaction chamber are usually separated, and piping for transporting a fluid is provided between them. Further, a shower head may be provided for the purpose of uniformly supplying the fluid to a surface of a substrate. In such a case, it takes about 0.5 seconds to 1.0 seconds for the material gas supplied from the mass flow controller to reach the position of the substrate via the piping including the shower head. This delay time can be a cause of reducing the production efficiency of semiconductors produced by ALD.

In addition, in a material gas passing through a piping, since shearing force due to viscosity acts on the material gas passing near the wall surface of the piping, the speed of the material gas passing near the wall surface of the piping becomes slower as compared with the speed of the material gas passing near the center of the piping. When a distribution in the speed at which the material gas flows in the piping occurs, a distribution occurs also in the time when the material gas reaches the substrate. As a result, the rise in the flow rate of the material gas at the position of the substrate slows down. The longer the piping becomes, the more noticeable the delay and slowdown in the rise of the material gas at the position of the substrate become, and it can cause a decline in the quality and production efficiency of semiconductors produced by ALD.

The present disclosure has been conceived in view of the above-mentioned problems, and one of the objectives is to improve the quality and production efficiency of semiconductors produced by ALD, for example, by shortening the time required for a flow rate of a fluid to rise at an action position where the fluid acts.

### Solution to Problem

A mass flow controller according to the present disclosure comprises a flow sensor which outputs a flow rate signal corresponding to a flow rate of a fluid, a flow control valve which controls the flow rate of the fluid by adjusting an opening degree of the valve, a flow rate setting means to which a flow rate setting value of the fluid is input and a control means which outputs a valve opening degree signal to the flow control valve, and performs flow rate control at an action position where the fluid acts at different flow rates depending on supply periods. The control means which the mass flow controller comprises is configured so as to perform flow rate control in the following manner according to each of a first period, a second period and a third period.

The first period is a period of time from a first time point that is a time point when a first setting value that is a flow rate setting value other than zero is input to the flow rate setting means to a second time point that is a time point when it is judged that the fluid has reached the action position, In the first period, the valve opening degree signal is output to the flow rate control valve such that a flow rate measured value determined based on the flow rate signal is larger than the first setting value.

The second period is a period of time from the second time point to a third time point that is a time point when a second setting value that is a flow rate setting value smaller than the first setting value is input to the flow rate setting means. In the second period, the valve opening degree signal is output to the flow rate control valve such that the flow rate measured value coincides with the first setting value.

The third period is a period of time from the third time point to a time point when the first setting value is next input. In the third period, the valve opening degree signal is output to the flow control valve such that the flow rate measured value coincides with the second setting value.

Furthermore, the control means is configured so as to repeatedly execute a control cycle consisting of the first period, the second period and the third period one or more times.

When the mass flow controller having the above-mentioned configuration is used, since the fluid flows at a flow rate larger than the first setting value that is a target flow rate setting value during the first period, the inside of the piping can be filled with the fluid in a short time. As a result, the time required for rise of the flow rate of the fluid reaching the position of the substrate (action position) is shortened. Moreover, when the first period ends and the second period begins, since the opening of the flow control valve is controlled such that the fluid flows at a flow rate equal to the first setting value that is the flow rate setting value, the flow rate of the fluid reaching the substrate never increases beyond the flow rate setting value.

In a preferred embodiment of the present disclosure, the mass flow controller according to the present disclosure further comprises a display means which displays at least the flow rate measured value. In addition, the control means is configured such that first information that is information different from the flow rate measured value is displayed by the display means in the first period and the flow rate measured value is displayed by the display means in the second period and the third period. When the mass flow controller having the above-mentioned configuration is used, since an excessive flow rate temporarily flowing through the mass flow controller during the first period is never displayed as the flow rate indicated value, incorrect information is never transmitted to an operator.

In another preferred embodiment of the present disclosure, the mass flow controller according to the present disclosure further comprises an abnormality handling means configured so as to perform an abnormality handling operation when it is judged that the flow rate measured value corresponds to an abnormal value. The abnormality handling operation is an operation including at least one action selected from a group consisting of issuing an alarm, decreasing the opening degree of the flow rate control valve and stopping the supply of the fluid, for example. In addition, the control means is configured such that a pseudo flow rate value that is a predetermined value other than the abnormal value is output as the flow rate measured value to the abnormality handling means and thereby the abnormality handling means does not execute the abnormality handling operation even when it is judged that the flow rate measured value corresponds to the abnormal value in the first period and the flow rate measured value is output to the abnormality handling means in the second period and the third period.

When the mass flow controller having the above-mentioned configuration is used, since the excessive flow rate temporarily flowing through the mass flow controller during the first period is never output to the abnormality handling means as the flow rate measured value, unnecessary abnormality handling operations is never executed.

### Advantageous Effects of Invention

When the mass flow controller according to the present disclosure is used, even in cases where on and off of flow of a fluid are repeated in short cycles as in the case of ALD, for example, the delay and slowdown in the rise of the flow rate of the fluid at a position of a substrate can be suppressed. As a result, the quality and production efficiency of semiconductors produced by ALD, for example, can be improved.

### Description of Embodiments

Embodiments for carrying out the present invention will be explained in detail below referring to drawings. The following explanation and drawings are just an exemplification of embodiments of the present invention, and embodiments of the present invention are not limited to the forms shown in the following explanation and drawings.

### <Application>

In one embodiment, the present invention performs flow rate control at an action position that is a position where a fluid acts at different flow rates depending on supply periods. For example, the present invention is an invention of a mass flow controller which intermittently supplies the fluid to the action position. The fluid supplied by the mass flow controller according to the present invention are attained remarkably.

As mentioned above, main use of mass flow controllers is semiconductor manufacturing. In semiconductor manufacturing, mass flow controllers are used for the purpose of controlling a flow rate of a gas used in a semiconductor manufacturing process. In this case, not only gases called material gases which are materials for patterned elements, conductive wires or insulating layers constituting semiconductor devices, but also gases used for etching processing of semiconductor devices, etc. Any gas used in the manufacturing process can be targeted in the flow rate control.

The mass flow controller according to the present invention supplies a fluid to the action position that is a position where the fluid acts. In the present specification, “action position” refers to a location where the fluid supplied by the mass flow controller achieves its original purpose of use. Hereafter, an example in which a mass flow controller according to the present invention is used to supply a material gas to a semiconductor manufacturing apparatus and a film is generated on a substrate by chemical vapor deposition (CVD) will be explained.

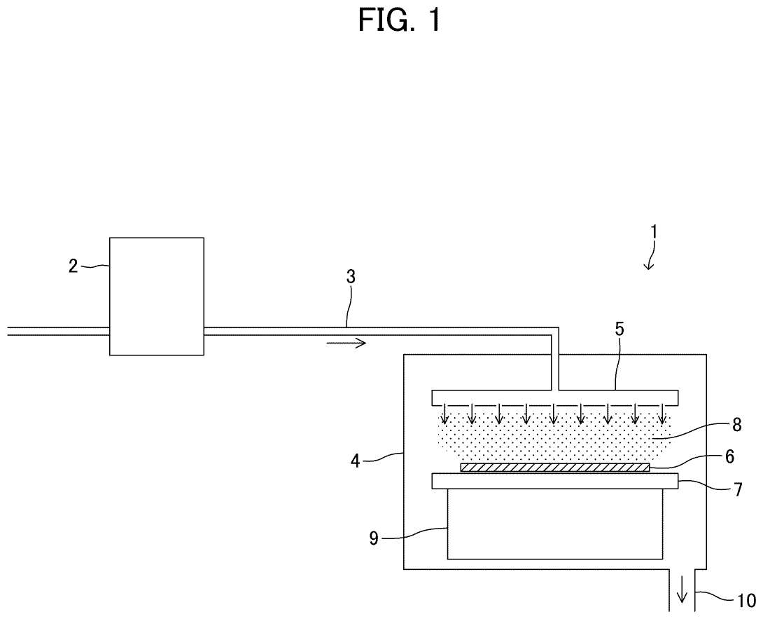

FIG. 1 is a schematic diagram for exemplifying a mode of use of the mass flow controller according to the present invention. A substrate 6 formed of silicon or other material is placed in advance inside a reaction chamber 4 of a semiconductor manufacturing apparatus 1. The substrate 6 is placed on a ground electrode 7 and heated to a predetermined temperature by a heater 9 provided below the ground electrode 7. The inside of the reaction chamber 4 is maintained in a vacuum state by a vacuum pump (not shown) connected to an exhaust piping 10. However, the term “vacuum state” in the present specification is not limited to a strictly vacuum state such as a high vacuum, but means a broad concept which may include a reduced pressure state as long as desired film can be formed (deposited). The evacuation speed of the vacuum pump is controlled by a conductance adjustment valve (not shown) provided between the exhaust piping 10 and the vacuum pump. By configuring the vacuum system of the semiconductor manufacturing apparatus 1 as shown in FIG. 1, the pressure inside the reaction chamber 4 can be maintained at a constant value regardless of the flow rate of the material gas supplied from the mass flow controller.

The mass flow controller 2 supplies the material gas to a gas supply piping 3 while controlling the flow rate of the material gas supplied from a supply source (not shown). The material gas flows through the gas supply piping 3 toward the right side of the drawing as indicated by an arrow, and reaches the reaction chamber 4 of the semiconductor manufacturing apparatus 1 which is in a vacuum state. A shower head 5 is provided directly above the substrate 6, and the material gas supplied by the gas supply piping 3 is discharged into the reaction chamber 4 from a large number of fine pores provided on the lower surface of the shower head 5, and thereafter the material gas reaches the surface of the substrate 6. The shower head 5 is provided for the purpose of uniformly supplying the material gas to the surface of the substrate 6.

The shower head 5 is made of an electric conductor and also serves as an RF electrode. The shower head 5 constitutes a pair of parallel plate electrodes together with a ground electrode 7 on which a substrate 6 is installed. When a high frequency power source is connected to the electrodes and electricity is turned on, RF discharge occurs between the electrodes, the material gas is ionized, and plasma 8 consisting of ions and high-speed electrons is generated. In the plasma 8, molecules constituting the material gas are easily decomposed by collisions of the high-speed electrons. Thereby, a chemical reaction with the material gas progresses on the surface of the substrate or the surface of the film deposited on the substrate, the desired film is formed on the substrate, and the material gas achieves its original purpose of use. Namely, in the embodiment exemplified in FIG. 1, the position of the surface of the substrate and the position of the surface of the film deposited on the substrate correspond to the action position in the present invention.

In the semiconductor manufacturing apparatus 1 exemplified in FIG. 1, the RF electrode 5 and the ground electrode 7 are arranged horizontally, and the substrate 6 is placed on the ground electrode 7. This electrode structure is referred to as a face down deposition and is the most basic electrode structure. However, the application of the mass flow controller according to the present invention is not limited to supplying a material gas to semiconductor manufacturing apparatus which adopts a face down deposition as its electrode structure. Also in usage forms other than the above-mentioned form, the location where the fluid achieves its original purpose of use can be specified as the action position in the same manner as mentioned above.

The mass flow controller according to the present invention performs flow rate control at the action position where the fluid acts at different flow rates depending on supply periods. In the present specification, “performing flow rate control at different flow rates depending on supply periods” refers to performing flow rate control such that a fluid is constantly supplied at a specific flow rate in a certain supply period, and the fluid is constantly supplied at a flow rate smaller than the above-mentioned specific flow rate or the supply of the fluid supply is stopped in a supply period different from the above-mentioned supply period, for a certain mass flow controller.

More specifically, the control means which the mass flow controller according to the present invention comprises is configured so as to perform flow rate control in the following manner according to each of a first period, a second period and a third period.

The first period is a period of time from a first time point that is a time point when a first setting value that is a flow rate setting value other than zero is input to the flow rate setting means to a second time point that is a time point when it is judged that the fluid has reached the action position, In the first period, the valve opening degree signal is output to the flow rate control valve such that a flow rate measured value determined based on the flow rate signal is larger than the first setting value.

The second period is a period of time from the second time point to a third time point that is a time point when a second setting value that is a flow rate setting value smaller than the first setting value is input to the flow rate setting means. In the second period, the valve opening degree signal is output to the flow rate control valve such that the flow rate measured value coincides with the first setting value.

The third period is a period of time from the third time point to a time point when the first setting value is next input. In the third period, the valve opening degree signal is output to the flow control valve such that the flow rate measured value coincides with the second setting value.

Furthermore, the control means is configured so as to repeatedly execute a control cycle consisting of the first period, the second period and the third period one or more times.

The lengths of the first period, second period and third period may all be equal, all may be different, or only some of them may be equal. Moreover, the first setting value which is newly input at the end of the third period (namely, at the start of the first period included in the next control cycle) may be equal to the input first setting value input at the start of the first period included in the previous control cycle, or they may be different from each other. Furthermore, the second setting value which is newly input at the start of the next third period may also be equal to the second setting value input at the start of the third period included in the previous control cycle, or they may be different from each other. Typically, the lengths of the first period, the second period and the third period are respectively constant over all control cycles, and the first setting value and the second setting value are also respectively constant.

Moreover, the second setting value that is a flow rate setting value smaller than the first setting value may be zero. In this case, the control means which the mass flow controller according to the present invention comprises outputs a valve opening degree signal for closing the flow control valve to the flow control valve in the third period. Namely, the mass flow controller according to the present invention intermittently supplies the fluid to the action position. In the present specification, “supplying fluid intermittently” means that a steady flow period (second period) in which the fluid is steadily supplied at a constant flow rate and a stop period (third period) in which the fluid supply is stopped are repeated alternately in a relatively short period for a certain mass flow controller. The lengths of the steady flow period and the stop period may be equal to or different from each other. The above-mentioned delay and slowdown in the rise of the fluid at the position of the substrate is a phenomenon which occurs at the moment of switching from the stop period to the steady flow period. Although this phenomenon rarely becomes a problem when the fluid is constantly supplied from the mass flow controller for a long period of time, it can become a problem when the fluid is supplied intermittently. Moreover, also in a case where the second setting value is not zero, the delay and slowdown in the rise of the fluid at the position of the substrate may occur at the moment when the first setting value is newly input at the start of the first period included in the next control cycle.

### <Hardware Configuration>

The mass flow controller according to the present invention comprises a flow sensor which outputs a flow rate signal corresponding to a flow rate of a fluid, a flow control valve which controls the flow rate of the fluid by adjusting an opening degree of the valve, a flow rate setting means to which a flow rate setting value of the fluid is input, and a control means which outputs a valve opening degree signal to the flow control valve. Since the control means performs control specific to the present invention, the control means will be explained in detail later, among these components.

The flow sensor may be any flow sensor as long as it is a known flow sensor which can be used in a mass flow controller. Specifically, for example, a thermal flow sensor, a pressure flow sensor, or the like can be used. In order to quickly detect changes in the flow rate of a fluid, it is preferable to adopt a flow sensor with a response time as short as possible.

The flow rate control valve may be any flow rate control valve as long as it is a known flow rate control valve which can be used in a mass flow controller. Specifically, for example, a flow control valve which comprises a valve body constituted by a diaphragm, a valve seat and an actuator for driving the diaphragm can be used. In order to supply as much fluid as possible during a short steady flow period, it is preferable to adopt a flow control valve with as large conductance as possible. The conductance is a coefficient indicating ease of flow of gas in piping, and is equal to a value obtained by dividing a mass flow rate of the gas flowing through the piping by the pressure difference between both ends of the piping.

The flow rate setting means may have any configuration as long as it has a function of transmitting a signal corresponding to data input as the flow rate setting value of the fluid controlled by the mass flow controller to the control means. As a specific example of the flow rate setting means, for example, a communication means provided for the purpose of receiving instructions by electrical signals from a control computer installed outside the mass flow controller can be exemplified.

The control means may have any configuration as long as it has the function of controlling the flow rate of the fluid by outputting the valve opening degree signal to the flow control valve to change the opening degree of the flow control valve. For example, the control means is an electronic control unit comprising a microcomputer as a main part. A microcomputer comprises a CPU (processor), ROM, RAM, nonvolatile memory, an interface, and the like. The CPU is configured so as to realize the above-mentioned functions by executing instructions (programs, routines) stored in the ROM.

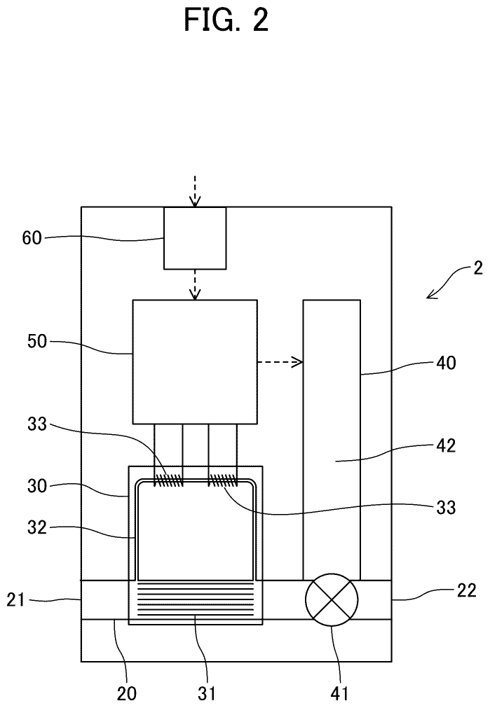

FIG. 2 is a schematic block diagram for showing an example of a configuration of the mass flow controller according to the present invention. It should be noted that FIG. 2 is intended to conceptually show the configuration of the mass flow controller according to the present invention and is not intended to specifically show the mass flow controller according to the present invention and the shape, structure and combination of its constituent members.

The mass flow controller 2 exemplified in FIG. 2 comprises a flow path 20 through which the fluid flows. The fluid flows into the inside of the mass flow controller 2 through an inlet 21 and flows out to the outside through an outlet 22. A flow sensor 30 and a flow control valve 40 are provided between the inlet 21 and the outlet 22 of the flow path 20. The flow sensor 30 comprises a bypass 31 provided inside the flow path 20, a sensor tube 32 branching from the flow path 20, and a pair of heating wires 33 wound around the upstream and downstream sides of the sensor tube 32. The bypass 31 has a function of keeping constant a ratio of the flow rate of the fluid flowing through the flow path 20 and the flow rate of the fluid branched to the sensor tube 32. The bypass 31 can be constituted by a laminar flow element made by bundling a large number of pipes, for example. The sensor tube 32 branches from the flow path 20 on the upstream side of the bypass 31 and rejoins the flow path 20 on the downstream side of the bypass 31. When a set of the heating wires 33 wound around the sensor tube 32 are energized and the fluid is flowing inside the sensor tube 32, since heat generated by the energization moves from the upstream side to the downstream side, a difference in resistance value occurs due to a temperature difference between the heating wires 33. By detecting this difference in resistance value, the flow rate of the fluid flowing inside the sensor tube 32 can be detected and, furthermore, the flow rate of the fluid flowing through the flow path 20 can be detected. Namely, the flow sensor 30 exemplified in FIG. 2 is a thermal type flow sensor.

The flow rate of the fluid detected by the flow sensor 30 is used to control the flow rate of the fluid flowing through the flow path 20. Specifically, the opening degree of the control valve 40 is controlled by the control means 50 which the mass flow controller 2 comprises such that the flow rate of the fluid detected by the flow sensor 30 coincides with the flow rate setting value input to the flow rate setting means 60 from a control computer (not shown). The flow control valve 40 comprises a valve body 41 and a drive mechanism 42 thereof. A valve opening degree signal as a control signal output from the control means 50 is input to the drive mechanism 42, and the opening degree of the valve body 41 is controlled. When the drive mechanism 42 is constituted by a piezoelectric element, a voltage signal can be used as the valve opening degree signal. Although the mass flow controller 2 exemplified in FIG. 2 comprises the thermal flow sensor 30, the mass flow controller 2 may comprise a pressure type flow sensor or other known flow sensor as the flow sensor 30 as mentioned above. Regardless of the configuration of the flow sensor 30, the mass flow controller 2 determines the flow rate of the fluid based on the flow rate signal output from the flow sensor 30, and controls the opening degree of the flow rate control valve 40 such that the determined flow rate coincides with the flow rate setting value.

As mentioned above, the flow rate setting value input to the flow rate setting means at the first time point is the first setting value that is a flow rate setting value that other than zero, and the flow rate setting value input to the flow rate setting means at the third time point is the first setting value that is a flow rate setting value smaller than the first setting value. Moreover, when the second setting value is zero, the flow rate setting value input to the flow rate setting means is a value other than zero (first setting value) during the steady flow period (second period), and the flow rate setting value input to the flow rate setting means is zero (second setting value) during the stop period (third period).

### <Operation of Control Means>

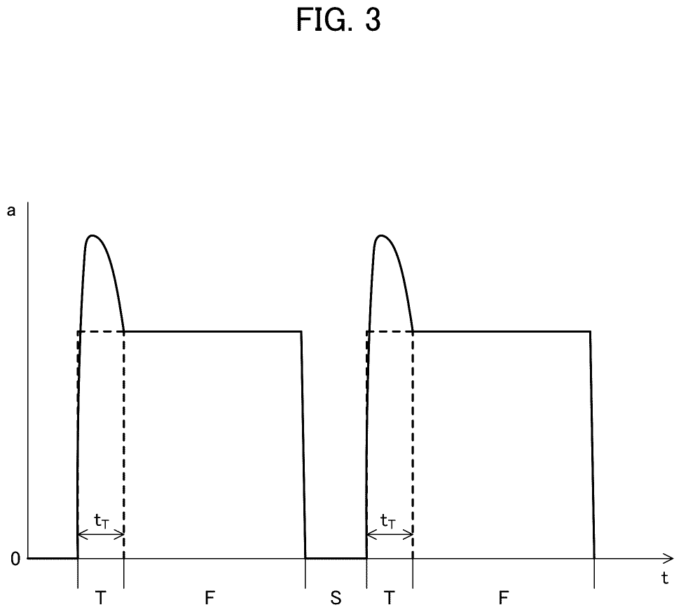

As mentioned above, the control means which the mass flow controller according to the present invention comprises is configured so as to perform a control operation specific to the present invention. Hereafter, with reference to FIG. 3 to FIG. 6, the operation of the control means in the present invention will be explained in detail while contrasting with the prior art. In the following explanation, a case where the second setting value that is a flow rate setting value smaller than the first setting value that is a flow rate setting value other than zero is equal to zero and the fluid is intermittently supplied to the action position through the mass flow controller by alternately providing the period during which the flow rate setting value is the first setting value and the period during which the flow rate setting value is the second setting value will be mentioned as an example.

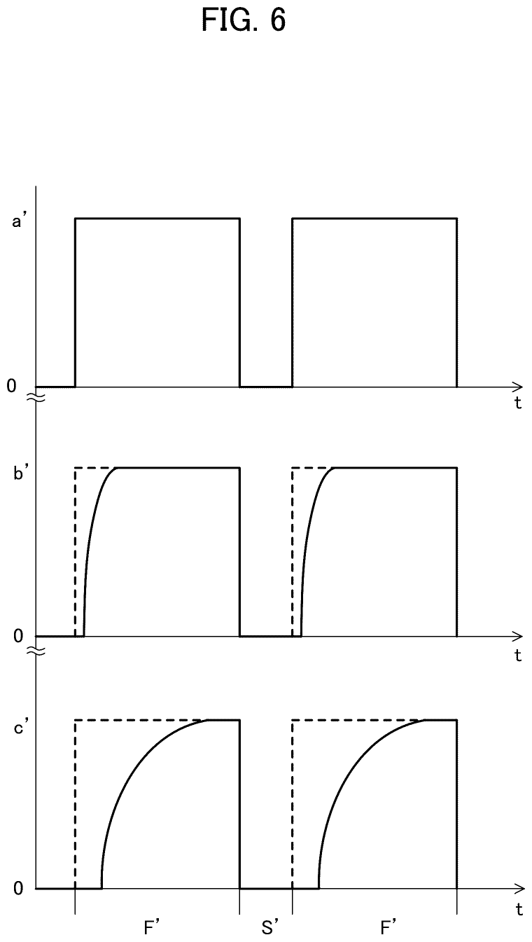

FIG. 6 is a graph for exemplifying changes with respect to time t of the intensity a′ of the valve opening degree signal, the measured flow rate b′ and the flow rate c′ of the material gas at the action position in a mass flow controller according to the prior art. In the following explanation, the intensity a′ of the valve opening degree signal will be simply referred to as “valve opening degree signal a′.” The temporal changes in the signal intensity and flow rate shown here represent changes over time in a case where the same manufacturing apparatus as the semiconductor manufacturing apparatus 1 exemplified in FIG. 1 is used and the mass flow controller 2 according to the present invention is replaced with a mass flow controller according to the prior art.

The valve opening degree signal a′ is the intensity of a signal input to the flow control valve from the control means which the mass flow controller according to the prior art comprises. For example, the relation between the intensity of the valve opening degree signal such as a current value or voltage value and the opening degree of the flow control valve may be a positive correlation or a negative correlation. Namely, the flow control valve may be configured such that the larger the intensity of the valve opening degree signal becomes, the larger the opening degree of the flow control valve becomes. Alternatively, on the contrary to this, the flow control valve may be configured such that the larger the intensity of the valve opening degree signal becomes, the smaller the opening degree of the flow control valve becomes. However, for the purpose of making the present invention easier to be understood, the following explanation will be made on the premise that there is a positive correlation between the intensity of the valve opening degree signal and the opening degree of the flow control valve. Namely, in the following explanation, a case where the opening degree of the flow control valve increases as the intensity of the valve opening degree signal increases will be mentioned.

The flow rate measured value b′ is a flow rate measured value specified based on a flow rate signal output by a flow sensor which a mass flow controller according to the prior art comprises. The flow rate c′ of the material gas at the action position is the flow rate of the material gas at a position of the surface of the substrate 6.

As shown in FIG. 6, in the mass flow controller according to the prior art, during a steady flow period F′ from the input of a flow rate setting value other than zero (first setting value) to the flow rate setting means until the input of a flow rate setting value equal to zero (second setting value) to the flow rate setting means, the valve opening degree signal a′ is fixed at a constant value. During the stop period S′ from the input of a flow rate setting value equal to zero (second setting value) to the flow rate setting means until the next input a flow rate setting value other than zero (first setting value), the valve opening degree signal a′ is fixed at zero. During the steady flow period F′, the control means controls the opening degree of the flow control valve, by outputting a controlled valve opening degree signal a′ to the flow control valve, such that the measured flow value b′ coincides with the flow rate setting value. During the stop period S′, the control means makes the flow rate of the fluid be zero by outputting a valve opening degree signal a′ for closing the flow control valve.

By executing the above-mentioned control operation, as shown in FIG. 6, the change in the flow rate measured value b′ with respect to time t approximately coincides with the change in the valve opening degree signal a′ with respect to time t in the mass flow controller according to the prior art. However, there is a slight time delay from the start of the steady flow period F′ until the flow rate measured value b′ begins to increase. Moreover, the rise of the flow rate after the flow rate measured value b′ begins to increase is slow, and it takes some time to reach a steady value. These delays are due to the fact that it takes time for the valve to actually start opening after the valve opening degree signal a′ is input to the flow control valve and/or the fact that it takes time for the material gas to move in the piping inside the mass flow controller, etc.

Next, referring to the graph of the flow rate c′ of the material gas at the action position shown in FIG. 6, both the time delay from the start of the steady flow period until the start of the increase in the flow rate c′ and the time delay from the start of the increase in the flow rate c′ until reaching the steady value are further larger than the time delay for the flow rate measured value b′. This is because it takes time for the material gas supplied from the mass flow controller to pass through the gas supply piping 3 and reach the position of the substrate 6 and a distribution occurs in the speed of the material gas while the material gas is flowing passing inside the gas supply piping 3, as mentioned above. The material gas which could not reach the position of the substrate 6 during one steady flow period F′ remains inside the gas supply piping 3 and the shower head 5. The remaining material gas is exhausted to the outside through the exhaust piping 10 or a purge piping (not shown) during the stop period S′, and does not contribute to film formation.

Comparing the changes in the valve opening degree signal a′ and the flow rate c′ of material gas at the action position with respect to time t shown in FIG. 6, it is found that the supply amount of the fluid at one steady flow period F′, which corresponds to the area of the graph, is largely reduced as compared with the setting due to the delay in the rise of the flow rate c′. In order to compensate this largely reduced supply amount, it is necessary either to increase the opening degree of the flow control valve by the valve opening degree signal a′ or to increase the length of the steady flow period F′ (extend the steady flow period F′). However, when the flow rate c′ of the material gas at the action position is increased by increasing the opening degree of the flow rate control valve, there is a risk that particles may be blown up inside the reaction chamber 4 by the flow of the material gas and contaminate the substrate 6. On the other hand, when the steady flow period F′ is extended, there is a risk that the film formation rate (deposition rate) in ALD may become slow and the production efficiency of semiconductors may decrease.

FIG. 3 is a graph for exemplifying a change with respect to time t of the intensity a of the valve opening degree signal in the mass flow controller according to the present invention. In the following explanation, the intensity a of the valve opening degree signal will be simply referred to as “valve opening degree signal a.” As shown in FIG. 3, the control means which the mass flow controller according to the present invention comprises performs flow rate control in the following manner according to each of the first period, the second period and the third period.

During the first period (which may be referred to as a “transitional period T” hereafter) from the first time point that is a time point when the first setting value that is a flow rate setting value other than zero is input to the flow rate setting means to the second time point that is a time point when it is judged that the material gas has reached the action position, the control means outputs the valve opening degree signal having an intensity larger than the intensity of the valve opening degree signal when the flow rate measured value coincides with the first setting value in a steady state to the flow rate control valve such that the flow rate measured value determined based on the flow rate signal is larger than the first setting value. Thereby, during the transitional period T (first period), the opening degree of the flow control valve is made larger than the opening degree of the flow control valve when the flow rate measured value coincides with the first setting value in the steady state, and the fluid is made to flow at a flow rate larger than the target first setting value. Such a control operation performed by the control means during the transitional period T (first period) is not found in the above-mentioned prior art, and is a control operation unique to the present invention. The length of the transitional period T shown in FIG. 3 is represented by the symbol t_{T}.

During the second period (which may be referred to as a “steady flow period F” hereafter) from the second time point to the third time point that is a time point when the second setting value that is a flow rate setting value smaller than the first setting value (equal to zero) is input to the flow rate setting means, the control means outputs the valve opening degree signal to the flow rate control valve such that the flow rate measured value coincides with the first setting value. In the present specification, the valve opening degree signal controlled such that the flow rate measured value coincides with the flow rate setting value may be referred to as a “controlled valve opening degree signal.” Specifically, the control is feedback control, for example. The flow rate measured value is determined by performing various corrections on the flow rate signal output from the flow sensor, for example. Specifically, the correction is correction using a known conversion factor due to a difference in the type of material gas, for example. The control operation performed by the control means during the steady flow period F (second period) is basically the same as the control operation during the steady flow period F′ in the above-mentioned prior art.

During the third period which may be referred to as a “stop period S” hereafter) from the third time point when the second setting value which is equal to zero is input until a time point when the first setting value is next input, the control means outputs the valve opening degree signal to the flow control valve such that the flow rate measured value coincides with the second setting value. In the example explained here, since the second setting value is equal to zero, the control means outputs the valve opening degree signal for closing the valve to the flow control valve such that the measured flow value becomes zero. The steady flow period F ends with the start of the stop period S (third period). The flow control valve remains closed from the start of the stop period S until the next input of the first setting value (that is a setting value other than zero and larger than the second setting value). At the end of the steady flow period F (namely, at the start of the stop period S), control in which the fluid is made to flow at a flow rate different from the flow rate setting value as in the above-mentioned transitional period T is not performed.

The mass flow controller according to the present invention intermittently supplies the material gas to the action position by outputting the valve opening degree signal a exemplified in FIG. 3 to the flow control valve. The control cycle consisting of the transitional period T (first period), the steady flow period F (second period) and the stop period S (third period) exemplified in FIG. 3 is repeated as many times as necessary until the original purpose of use of the material gas is achieved. During the period in which the control cycle is repeatedly executed in this way, the profile of the valve opening degree signal a exemplified in FIG. 3 may be constant, or either one or both of the intensity and time of the valve opening degree signal a may be changed.

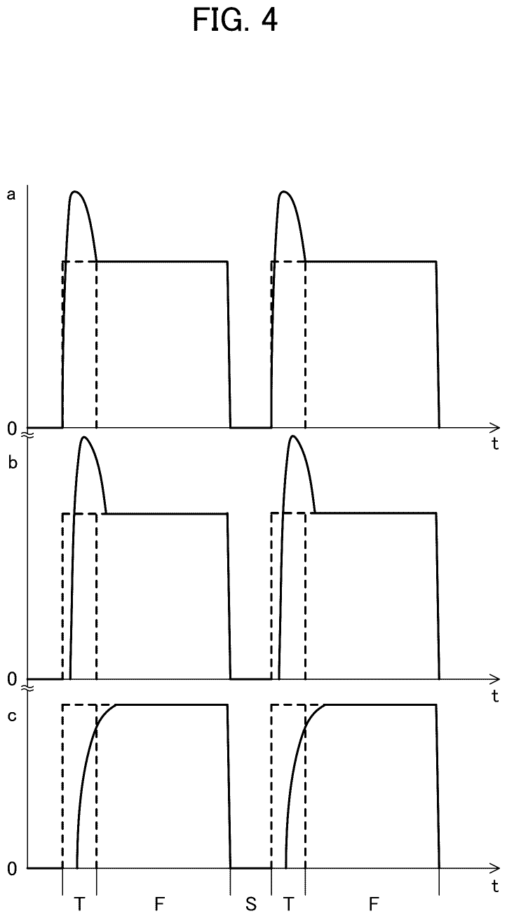

FIG. 4 is a graph for exemplifying changes with respect to time t of the intensity a of the valve opening degree signal, the flow rate measured value b and the flow rate c of the material gas at the action position in the mass flow controller according to the present invention. The temporal changes in the signal and flow rates shown here represent the temporal changes in the semiconductor manufacturing apparatus 1 exemplified in FIG. 1. The valve opening degree signal a is a signal input to the flow rate control valve from the control means which the mass flow controller according to the present invention comprises. The flow rate measured value b is a flow rate measured value specified based on a flow rate signal output by a flow sensor which the mass flow controller according to the present invention comprises. The flow rate c of the material gas at the action position is a flow rate of the material gas at the position of the surface of the substrate 6. The graph of the valve opening degree signal a in FIG. 4 is the same as the graph in FIG. 3, and is reproduced in FIG. 4 for comparison with the graphs of the flow rate measured value b and the material gas flow rate c at the action position.

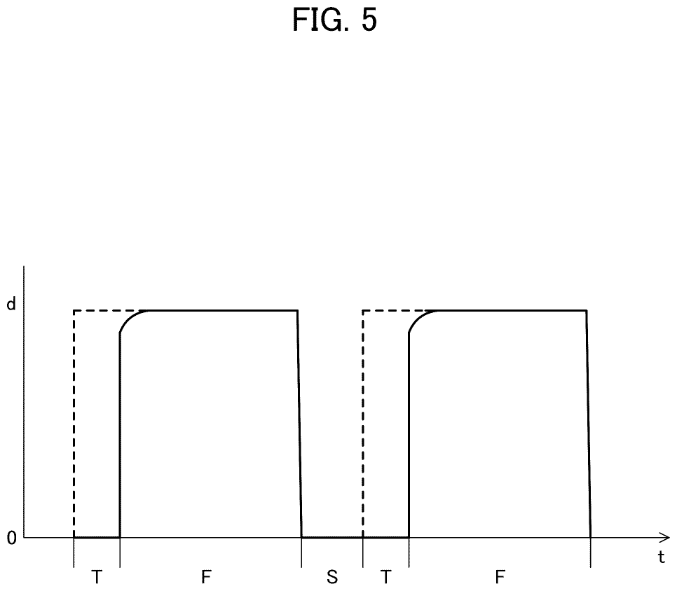

By executing the control operation based on the valve opening degree signal a shown in FIG. 3, the change with respect to time t of the flow rate measured value b almost coincides with the change with respect to time t of the valve opening degree signal a in the mass flow controller according to the present invention, as shown in FIG. 4. In the period corresponding to the transitional period T in FIG. 4, there is a slight time delay from the start of the transitional period T until the flow rate measured value b begins to increase, as in the case of the start of the steady flow period in the prior art shown in FIG. 5. Moreover, the rise of the flow rate c after the flow rate measured value b begins to increase is slightly slower as compared with the rise of the valve opening degree signal a. However, since an excessive valve opening degree signal is output to the flow control valve during the transitional period T in the present invention, these delays are limited as compared with the case of the prior art.

Next, referring to the graph of the flow rate c of the material gas at the action position in FIG. 4, both the time delay from the start of the transitional period T until the flow rate c begins to increase and the time delay after the flow rate c begins to increase until the flow rate c reaches a steady value are smaller as compared with those in the case of the flow rate c′ of the fluid at the action position in the prior art shown in FIG. 6. This is because the material gas excessively supplied from the mass flow controller 2 quickly fills the inside of the gas supply piping 3 and the shower head 5 during the period from the start of the transitional period T until the start of the steady flow period F, which is unique to the present invention and therefore the flow rate c which is approximately equal to the flow rate setting value in the steady flow period F can be easily achieved at the start of the steady flow period F. Also in the mass flow controller according to the present invention, the material gas which could not reach the position of the substrate 6 during one steady flow period F is discharged to the outside through the exhaust piping 10 or a purge piping (not shown) during the stop period S and does not contribute to film formation. However, the amount of the material gas wastefully discharged in the present invention is limited.

Comparing the changes in the valve opening degree signal a and the flow rate c of the material gas at the action position with respect to time t shown in FIG. 4, although a divergence between them is observed in the transitional period T, they coincide well with each other in the steady flow period F. As Compared with the large decrease in the supply amount of material gas seen in the flow rate c′ in FIG. 6, a shortfall in the flow rate c during the transitional period T in FIG. 4 is small. For this reason, this shortfall can be sufficiently compensated for by slightly increasing the flow rate setting value or by slightly extending the steady flow period F. Therefore, by using the mass flow controller according to the present invention, it is possible to improve the quality and production efficiency of semiconductors produced by ALD, for example, as compared with conventional technologies.

### <Arrival of Fluid at Action Position>

In the mass flow controller according to a preferred embodiment of the present invention, the length of the transitional period T (first period) is predetermined or the length of the transitional period T is determined while the first period is in progress. In order to execute the above-mentioned control by the control means which the mass flow controller according to the present invention comprises, it is necessary to know the time from when the mass flow controller starts supplying the fluid until the fluid reaches the action position under certain conditions. By this time, the length of the transitional period t is determined. The control means outputs an excessive valve opening degree signal to the flow rate control valve while the transitional period T continues. When it is judged that the fluid has reached the action position, the transitional period T ends and the steady flow period F (second period) begins, and the control means outputs the controlled valve opening degree signal to the flow rate control valve. Specifically, the control means outputs the valve opening degree signal to the flow control valve such that the measured flow value coincides with the first setting value. The transitional period T starts at the first point that is a time point when the first setting value that is a flow rate setting value other than zero is input to the flow rate setting means. However, as for the end of the transitional period T and the start of the steady flow period F, there is no input signal to trigger them. Therefore, in order for the control means to switch the operation in the transitional period T to the operation in the steady flow period F, the optimum length tr of the transitional period T under certain conditions of use must be determined in advance or must be determined while the transitional period T is in progress.

There are several methods for determining the optimal value of the length tr of the transitional period T. The first method is a method in which the arrival of the fluid at the action position is detected during the transitional period T. Specifically, for example, it is possible to constantly measure the pressure inside the reaction chamber 4 shown in FIG. 1 and judge that a time point when the pressure begins to increase is the time point when the material gas has reached the action position (namely, the second time point). As mentioned above, since the pressure inside the reaction chamber 4 is kept in a vacuum state by the vacuum pump, the pressure inside the reaction chamber 4 rises at the moment when the material gas is released into the reaction chamber 4 from the pores of the shower head 5. Therefore, for example, it is possible to further provide a pressure sensor which outputs a pressure signal corresponding to the pressure at the action position and determine a time point when an increase of the pressure specified based on the pressure signal output from the pressure sensor after the first time point becomes a predetermined first threshold value or more as the second time point.

However, since the above-mentioned change in the pressure is slight when the amount of material gas supplied is small as compared with the volume of the reaction chamber 4, it is preferable that a pressure gauge with high sensitivity is used as the above-mentioned pressure sensor in such a case. Specifically, known pressure gauges such as a Pirani gauge, a diaphragm gauge, an ion gauge and a Penning vacuum gauge, etc. can be used.

The second method for determining the optimal value of the length tr of the transitional period T is a method in which a relation between the growth rate of the film formed (deposited) by the material gas reaching the surface of the substrate and the length of the transitional period T is examined. In a case where the length of the steady flow period F and the flow rate setting value are fixed to the minimum values at which one atomic layer can be formed and the length of the transitional period T is being gradually shortened, the growth rate of the film begins to decrease when the length of the transitional period T becomes a certain value or less. The length tr of the transitional period T immediately before the film growth rate starts to decrease at this time can be considered as the optimum value to be determined. Although the thickness of the film deposited on the substrate in one steady flow period F is very small at one atomic layer, the thickness of the entire atomic layer repeatedly deposited by ALD can be measured by a known method.

The third method for determining the optimal value of the length t_{T} of the transitional period T is a method in which the length t_{T} of the transitional period T is estimated based on the conductance value obtained from the type of the gas, temperature and the inner diameter and length of the gas supply piping 3. Conductance values for commonly used gases are known. When the conductance is known, since it is possible to calculate the time required for the gas released from the mass flow controller 2 to fill the gas supply piping 3, the length t_{T} of the transitional period T can be estimated from the time. Note that the method for determining the optimal value of the length t_{T} of the transitional period T is not limited to the above-mentioned methods.

The optimum value of the length t_{T} of the transitional period T obtained by the methods exemplified above can be input in advance to the control means of the mass flow controller according to the present invention or can be stored in a computer provided outside the mass flow controller and input to the control means when necessary, and thereby can be used for control by the control means, for example. In the case of the above-mentioned first method, the length t_{T} of the transitional period T may be determined on a case-by-case basis by using the mass flow controller and measuring the change in pressure inside the reaction chamber 4 in situ at the same time.

### <Display Means>

In a preferred embodiment of the present invention, the control means which the mass flow controller according to the present invention comprises further comprises a display means which can display at least the flow rate measured value, and the control means is configured such that first information that is information different from the flow rate measured value is displayed by the display means in the transitional period T (first period) and the flow rate measured value is displayed by the display means in the steady flow period F (second period) and the stop period S (third period). Typically, the display means in this preferred embodiment is provided for the mass flow controller according to the present invention to display and inform the operator of the current flow rate. Specifically, the flow rate displayed by the display means may be a flow rate displayed as a digital value, may be a flow rate indicated by an analog display such as an electromagnetic meter, for example, or may be a flow rate displayed by other known display methods.

The above-mentioned “first information” is information displayed by the display means in place of the flow rate measured value during the transitional period T, and may be a predetermined constant value (for example, zero) or a character string and/or an image such as a pictorial image for providing an operator with some information.

FIG. 5 is a graph for exemplifying a change with respect to time t of the flow rate indicated value d displayed by the display means in a preferred embodiment. The time axis that is the horizontal axis in FIG. 5 is the same as the time axes shown in FIG. 3 and FIG. 4. As shown in FIG. 5, during the transitional period T, the display means displays zero as the first information. The reason why the display means is configured so as to display zero during the transitional period T rather than the flow rate measured value determined based on the flow rate signal is because there is a risk that incorrect information may be conveyed to the operator since a flow rate larger than the flow rate setting value input to the flow rate setting means will be displayed if the flow rate measured value b as exemplified in FIG. 4, for example, is displayed as it is during the transitional period T. As mentioned above, the excessive flow rate during the transitional period T exemplified in FIG. 4 is consumed exclusively for filling the gas supply piping 3 and the shower head 5, and does not contribute to the film formation (deposition) on the substrate 6 during the steady flow period F at all. By displaying zero during the transitional period T, the display means can convey information closer to reality regarding the flow rate of the fluid controlled by the mass flow controller, namely information on the flow rate of the material gas at the action position, to the operator.

As shown in FIG. 5, in the steady flow period F and the stop period S, the display means displays the flow rate measured value. When the transitional period T ends and the filling of the gas into the gas supply piping 3 is completed and the steady flow period F begins, the controlled valve opening degree signal is output from the control means to the flow control valve instead of the previous excessive valve opening degree signal such that the flow rate measured value determined based on the flow rate signal coincides with the flow rate setting value (first setting value). In the steady flow period F, the flow rate measured value basically shows a constant value as shown in the graph of the flow rate measured value b exemplified in FIG. 4. This flow rate also coincides with the flow rate of the material gas at the action position. Subsequently, when entering the stop period S, the measured flow rate of the material gas flowing by the mass flow controller becomes zero (second setting value). Moreover, as mentioned above, during the stop period S, the excess material gas is exhausted and does not contribute to the film formation. Therefore, the flow rate of the material gas at the action position becomes substantially zero.

As mentioned above, in the preferred embodiment, the flow rate indicated values displayed throughout the steady flow period F and the stop period S do not differ largely from the substantial flow rate of the material gas at the action position. Moreover, when the first information that is the information displayed on the display means in the transitional period T is set to zero as mentioned above, it is possible to bring the flow rate indicated value displayed by the display means to be not different largely from the substantial flow rate of the material gas at the action position also in the transitional period T. However, as mentioned above, the first information does not necessarily have to be a numerical value of zero, and it may be a predetermined constant value other than zero, or it may be a character string and/or an image such as a pictorial image for providing an operator with some information, for example. As specific examples of such information, information indicating that the flow rate measured value is zero or information indicating that the flow rate control by the mass flow controller is in the transitional period T, etc. can be exemplified, for example, but is not limited to these.

When the mass flow controller having the above-mentioned configuration is used, since the excessive flow rate temporarily flowing through the mass flow controller during the transitional period T (first period) is never displayed as the flow rate indicated value, incorrect information is never transmitted to an operator.

### <Abnormality Handling Means>

In another preferred embodiment of the present invention, the mass flow controller according to the present invention further comprises an abnormality handling means configured so as to perform an abnormality handling operation when it is judged that the flow rate measured value corresponds to an abnormal value. Specific examples of conditions under which the flow rate measured value is judged to correspond to an abnormal value may include a fact that a difference between the flow rate measured value and the flow rate setting value is a predetermined second threshold value or more and/or a fact that the flow rate measured value is a predetermined third threshold value or more. However, the conditions are not limited to these, and can be determined properly depending on the specifications required for equipment such as semiconductor manufacturing apparatus to which the mass flow controller according to the present invention is applied.

Moreover, the abnormality handling operation is an operation including at least one action selected from a group consisting of issuing an alarm, decreasing the opening degree of the flow rate control valve and stopping the supply of the fluid, etc., for example. The alarm may be an image and/or text displayed by a display device such as the above-mentioned display means, a sound and/or voice blown by a sound device such as a buzzer and/or a speaker, or light emitted by a warning light, etc., for example.

In addition, the control means in this preferred embodiment is configured so as to output a pseudo flow rate value that is a predetermined value other than the abnormal value even when it is judged that the flow rate measured value corresponds to the abnormal value in the transitional period T (first period). As a result, by the control means outputting the valve opening degree signal having an intensity larger than the intensity of the valve opening degree signal when the flow rate measured value coincides with the first setting value in a steady state to the flow rate control valve, it is possible to prevent the abnormality handling means from executing the abnormality handling operation due to such an excessive flow rate during the transitional period T in which the flow rate measured value determined based on flow rate signal is larger than the first setting value. On the other hand, in the steady flow period F (second period) and the stop period S (third period), the control means is configured so as to output the flow rate measured value to the abnormality handling means.

When the mass flow controller having the above-mentioned configuration is used, since the excessive flow rate temporarily flowing through the mass flow controller during the transitional period T is never output to the abnormality handling means as a flow rate measured value, unnecessary abnormality handling operation is never executed.

### <Intensity of Valve Opening Degree Signal as Function of Time>

In a preferred embodiment of the present invention, in the mass flow controller according to the present invention, the intensity of the valve opening degree signal in the transitional period T (first period) varies as a function of time. Here, the “intensity of the valve opening degree signal varies as a function of time” means that the intensity of the valve opening degree signal output to the flow control valve is not fixed at a constant value, but changes over time. For example, referring to the valve opening degree signal a exemplified in FIG. 3, the valve opening degree signal in the transitional period T (first period) changes so as to rapidly increases at the same time as the start of the transitional period T, reach the maximum value in a short time and thereafter immediately start to decrease, and coincide with the valve opening degree signal in the steady flow period F (second period) at the end of the transitional period T. The maximum value of the valve opening degree signal a in this case may be the valve opening degree signal corresponding to the maximum opening degree by the design of the flow control valve, or may be the valve opening degree signal with a value smaller than the maximum opening degree by the design of the flow control valve. In this way, since the valve opening degree signal changes as a function of time rather than a constant value, the transition from the transitional period T to the steady flow period F is performed smoothly, and overshooting of the flow rate at the start of the steady flow period F is prevented.

In a preferred embodiment, the valve opening degree signal in the transitional period T expressed as a function of time is not limited to the functions of time as exemplified in FIG. 3 and FIG. 4, but may be any function of time. However, since the period of the transitional period T is short, for example, less than 1 second, it is not very realistic to set a complicated function, and there is little advantage in terms of effectiveness. Basically, any function having at least one peak as exemplified in FIG. 3 and FIG. 4 can exhibit the effect of the transitional period T in the present invention.

### <Discharge of Residual Gas During Stop Period>

When the mass flow controller according to the present invention is used in the embodiment exemplified in FIG. 1, the material gas filled in the gas supply piping 3 remains immediately after the valve opening degree signal a is set to zero and thereby the flow control valve is closed, as mentioned above. A supplementary explanation will be given regarding the handling of this gas remaining in the gas supply piping 3. For example, in order to alternately switch the type of material gas in the process of film formation (deposition) in ALD, it is necessary to exhaust the gas remaining in the gas supply piping 3, the shower head 5 and the reaction chamber 4 to the outside during the stop period S (third period). For this purpose, in general, the material gas is generally discharged using a purge gas consisting of an inert gas, or the material gas is evacuated using the exhaust piping 10. In these cases, since the gas supply piping 3 is long, it may take time to exhaust all the material gas remaining there.

There are several possible solutions to the above problems. For example, by providing one solenoid valve on each of the upstream side and downstream side of the gas supply piping 3, providing a purge gas inlet on the downstream side of the solenoid valve on the upstream side, and providing a purge gas outlet on the upstream side of the solenoid valve on the downstream side. The material gas remaining in the gas supply piping 3 can be discharged from an outlet for the purge gas in a short time without passing through the reaction chamber 4 and shower head 5.

Moreover, for example, in a case where both the upstream solenoid valve and the downstream solenoid valve provided as mentioned above are closed to leave the material gas remaining in the gas supply piping 3 and then the material gas is used, the transitional period T (first period) may be started from a state where the inside of the gas supply piping 3 is filled with the material gas. In this case, the length of the transitional period T (first period) and/or the maximum value of the intensity of the valve opening degree signal, etc. may be set to a value different from a value in a case where no material gas remains in the gas supply piping 3 according to the amount of the material gas remaining in the gas supply piping 3. Further, an exclusive gas supply piping 3 may be prepared for each type of the material gas used for film formation, and the downstream ends of a plurality of the gas supply piping 3 may be individually connected to the reaction chamber 4 or the shower head 5.

Moreover, even when the material gas remains in the reaction chamber 4 at the beginning of the stop period S, film formation can be stopped quickly by temporarily cutting off the connection between the high frequency power source and the electrode to stop the generation of the plasma 8, for example. By performing such an operation, it is possible to prevent incomplete film formation during the process of discharging the material gas to the outside.

### <When the Second Setting Value is Not Zero>

In the above explanation, a case where the second setting value that is a flow setting value smaller than the first setting value that is a flow setting value other than zero is equal to zero, the period in which the flow setting value is the first setting value and the period in which the flow setting value is the second setting value are alternatingly provided and thereby the fluid is intermittently supplied to the action position by the mass flow controller has been explained. Therefore, in the above explanation, the third period following the first period that is the transitional period T and the second period that is the steady flow period F has been referred to as the “stopping period S.”

However, as mentioned above, the second setting value that is the flow rate setting value in the third period is the flow rate setting value smaller than the first setting value that is the flow rate setting value in the first period and the second period, and is not necessarily zero. When the second setting value is not zero in this way, in the mass flow controller according to the present invention, as a result of the operation by the control means, instead of the stop period S (third period) in which the flow rate measured value is zero, a period during which the flow rate setting value that is smaller than the first setting value that is the flow rate setting value in the steady flow period F (second period) and is not zero is input to the flow rate input means as the second setting value (which may be referred to as a “low flow period L” hereafter) is the third period. In this case, the operation of the mass flow controller and its effects in the transitional period T (first period) from the first time point that is a time point when the first setting value is input as the flow rate setting value until the second time point that is a time point when it is judged that the fluid has reached the action position, output said valve opening degree signal to said flow rate control valve such that a flow rate measured value determined based on said flow rate signal is larger than said first setting value are the same as those in the respective embodiments of the present invention mentioned so far, except that the initial value of the flow rate measured value is not zero.

In accordance with this embodiment, when supplying the material gas to semiconductor manufacturing apparatus from a plurality of the mass flow controllers, while continuing the supply of a certain material gas by using one mass flow controller during the low flow period L, it is possible to other material gases can be intermittently supplied by using one or more mass flow controllers according to any of the embodiments of the present invention.

1. A mass flow controller, comprising:
a flow sensor which outputs a flow rate signal corresponding to a flow rate of a fluid,
a flow control valve which controls the flow rate of said fluid by adjusting an opening degree of the valve,
a flow rate setting means to which a flow rate setting value of said fluid is input, and
a control means which outputs a valve opening degree signal to said flow control valve, and
said mass flow controller performs flow rate control at an action position where said fluid acts at different flow rates depending on supply periods,
wherein said control means is configured so as to:
in a first period from a first time point that is a time point when a first setting value that is a flow rate setting value other than zero is input to said flow rate setting means to a second time point that is a time point when it is judged that said fluid has reached said action position, output said valve opening degree signal to said flow rate control valve such that a flow rate measured value determined based on said flow rate signal is larger than said first setting value,
in a second period from said second time point to a third time point that is a time point when a second setting value that is a flow rate setting value smaller than said the first setting value is input to said flow rate setting means, output said valve opening degree signal to said flow rate control valve such that said flow rate measured value coincides with said first setting value,
in a third period from said third time point to a time point when said first setting value is next input, output said valve opening degree signal to said flow control valve such that said flow rate measured value coincides with said second setting value, and
repeatedly execute a control cycle consisting of said first period, said second period and said third period one or more times.

2. The mass flow controller according to claim 1, wherein:
the length of said first period is predetermined or the length of said first period is determined while said first period is in progress.

3. The mass flow controller according to claim 2, further comprising:
a pressure sensor which outputs a pressure signal corresponding to the pressure at said action position, and
said control means is configured so as to define as said second point a time point when an increase in the pressure specified based on said pressure signal after said first time point becomes a predetermined first threshold or more.

4. The mass flow controller according to claim 1, wherein:
said control means is configured so as to output said valve opening degree signal to said flow control valve such that the opening degree of said flow rate control valve in said first period starts increasing at said first time point, starts decreasing when reaching a predetermined maximum opening degree, and coincides with an opening degree corresponding to said first setting value at said second time point.

5. The mass flow controller according to claim 4, wherein:
said control means is configured such that the intensity of said valve opening degree signal in said first period varies as a function of time.

6. The mass flow controller according to claim 1, further comprising a display means which can display at least said flow rate measured value, and
said control means is configured such that:
in said first period, first information that is information different from said flow rate measured value is displayed by said display means, and
in said second period and said third period, said flow rate measured value is displayed by said display means.

7. The mass flow controller according to claim 6, wherein:
said first information is information indicating that said flow rate measured value is zero or information indicating that the flow rate control by said mass flow controller is in said first period.

8. The mass flow controller according to claim 1, further comprising an abnormality handling means configured so as to perform an abnormality handling operation that is an operation including at least one action selected from a group consisting of issuing an alarm, decreasing the opening degree of said flow rate control valve and stopping the supply of said fluid when it is judged that said flow rate measured value corresponds to an abnormal value, and
said control means is configured such that:
in said first period, even when it is judged that said flow rate measured value corresponds to the abnormal value, a pseudo flow rate value that is a predetermined value other than said abnormal value is output as said flow rate measured value to said abnormality handling means and thereby said abnormality handling means does not execute said abnormality handling operation, and
in said second period and said third period, said flow rate measured value is output to said abnormality handling means.
